(19) United States
(12) Patent Application Publication
(10) Pub. No.: US 2016/0192390 A1
(43) Pub. Date: Jun. 30, 2016

(54) METHOD FOR TRANSMITTING DATA BASED ON LIMITED CONTENTION

(71) Applicant: ELECTRONICS AND TELECOMMUNICATIONS RESEARCH INSTITUTE, Daejeon (KR)

(72) Inventors: Nam Suk Lee, Daejeon (KR); Yong Seouk Choi, Daejeon (KR)

(73) Assignee: ELECTRONICS AND TELECOMMUNICATIONS RESEARCH INSTITUTE, Daejeon (KR)

(21) Appl. No.: 14/980,171

(22) Filed: Dec. 28, 2015

(30) Foreign Application Priority Data
Dec. 30, 2014 (KR) 10-2014-0192956
Mar. 30, 2015 (KR) 10-2015-0044536

(51) Int. Cl. H04W 72/12; H04W 72/08; H04W 72/04

(52) U.S. Cl. CPC H04W 72/1289; H04W 72/1284; H04W 72/0446; H04W 72/0486; H04W 72/08

(57) ABSTRACT

Disclosed is a method for transmitting data between a terminal and a base station. The method includes: being assigned a scheduling request identifier (SRID) through a connection with the base station, in the terminal; configuring a scheduling request (SR) message and transmitting the scheduling request message to the base station when uplink traffic is generated, in the terminal; assigning an uplink resource based on the scheduling request message, in the base station; and transmitting data using the uplink resource, in the terminal.

### CROSS-REFERENCE TO RELATED APPLICATION

This application claims the benefit of priority to Korean Patent Application No. 10-2014-0192956, filed on Dec. 30, 2014 in the Korean Intellectual Property Office, and Korean Patent Application No. 10-2015-0044536, filed on Mar. 30, 2015 in the Korean Intellectual Property Office, the disclosure of which is incorporated herein in its entirety by reference.

### BACKGROUND OF THE INVENTION

1. Field of the Invention

The present disclosure relates to a method for performing scheduling request (SR) by a terminal in order to request an uplink resource to a base station in a mobile communication system.

2. Description of the Related Art

When a terminal desires to transmit uplink data in a mobile communication system, the terminal should be assigned an uplink resource from a base station. To this end, the terminal may request the uplink resource to the base station, and transmit data through the assigned resource.

FIG. 1 is a diagram illustrating an uplink resource request procedure according to the related art. The base station may assign a scheduling request cycle in which the terminal may perform an uplink scheduling request and a resource that can transmit a scheduling request signal (SR). When uplink traffic is generated (101), the terminal may transmit the SR signal to the base station in the scheduling request cycle (102). The base station may receive the SR signal, and assign the uplink resource that can transmit buffer state information of the terminal (103). The terminal may transmit the buffer state information to the base station using the assigned uplink resource (104). The buffer state information may indicate size information of data for uplink transmission stored in a buffer in the terminal. When the base station assigns uplink resource according to the buffer state information (105), the terminal may transmit uplink data to the base station using the assigned uplink resource (106).

In the above described related art, an uplink resource request procedure may be increased, and a delay from the scheduling request to the data transmission may be increased. The related art may not be suitable for a mobile communication system which requires a low-delay data transmission.

### SUMMARY OF THE INVENTION

The present disclosure has been made in view of the above problems, and provides a method for reducing an uplink data transmission delay through a rapid scheduling request in a mobile communication system.

In accordance with an aspect of the present disclosure, a method for transmitting data between a terminal and a base station includes: being assigned a scheduling request identifier (SRID) through a connection with the base station, in the terminal; configuring a scheduling request (SR) message and transmitting the scheduling request message to the base station when uplink traffic is generated, in the terminal; assigning an uplink resource based on the scheduling request message, in the base station; and transmitting data using the uplink resource, in the terminal.

Being assigned a scheduling request identifier includes receiving an uplink resource request related parameter which is broadcasted by the base station. Receiving an uplink resource request related parameter includes receiving at least one of the number of frame, the number of sub frame, the number of a SR channel per sub-frame, and the number of opportunity which is able to transmit the SR message per SR channel. Configuring a scheduling request message includes configuring the scheduling request message using a specified bit value of the scheduling request identifier, a buffer size in which the uplink traffic is stored, the bit value, and a cyclic redundancy check (CRC) value for the buffer size. Transmitting the scheduling request message includes transmitting the scheduling request message based on opportunity index indicating a scheduling request channel.

Transmitting the scheduling request message includes determining the opportunity index based on a following equation.

Opportunity Index=M%N_to [Equation]

(where, the M is most significant bit (MSB) (Nsr−u) bits, the Nsr is a length of the scheduling request identifier, the U is a specified bit value of the scheduling request identifier, the N_to is No*Nc*Ns (when Nf is 1) or No*Nc*Ns*Nf (when Nf is greater than 1), the Nf is the number of frame, the Ns is the number of sub-frame, the Nc is the number of a SR channel per sub-frame, and the No is the number of opportunity which is able to transmit the SR message per SR channel). Transmitting the scheduling request message includes driving a response timer corresponding to the scheduling request message.

Assigning an uplink resource includes: configuring a SR radio network temporary identifier (RNTI), in the base station; and assigning the uplink resource through a physical downlink control channel (PDCCH), in the base station. Configuring the SR RNTI further includes performing a CRC for the scheduling request message. Assigning an uplink resource includes assigning the uplink resource based on a size of a buffer storing the uplink traffic. Configuring a scheduling request (SR) message and transmitting includes forming a scheduling request channel for transmitting the scheduling request message using a CQI message.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating an uplink resource request procedure according to the related art;

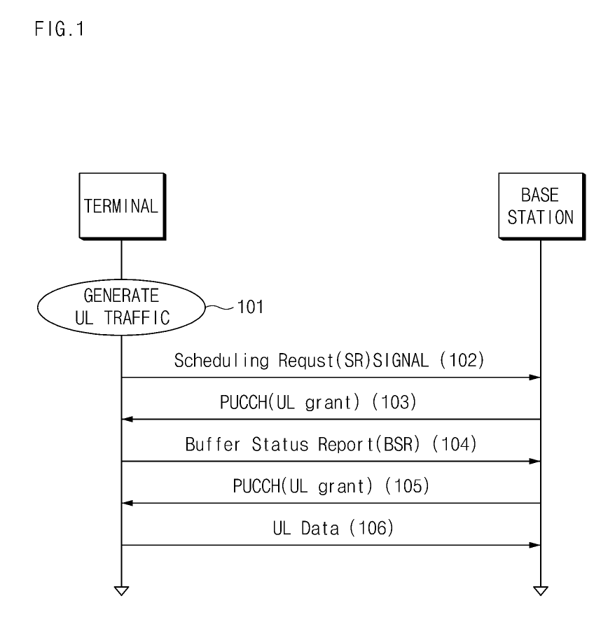

FIG. 2 is a signal flow diagram illustrating a step for requesting an uplink resource according to various embodiments of the present disclosure;

FIG. 3 is a flow chart illustrating a process of requesting an uplink resource by a terminal according to various embodiments of the present disclosure;

FIG. 4 is a diagram illustrating a buffer size table according to various embodiments of the present disclosure;

FIG. 5 is a diagram illustrating a configuration of SR RNTI according to various embodiments of the present disclosure;

FIG. 6 is a diagram illustrating a method of configuring an SR channel using a CQI channel according to various embodiments of the present disclosure; and

FIG. 7 is a flow chart illustrating a procedure for processing an uplink resource in a base station according to various embodiments of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

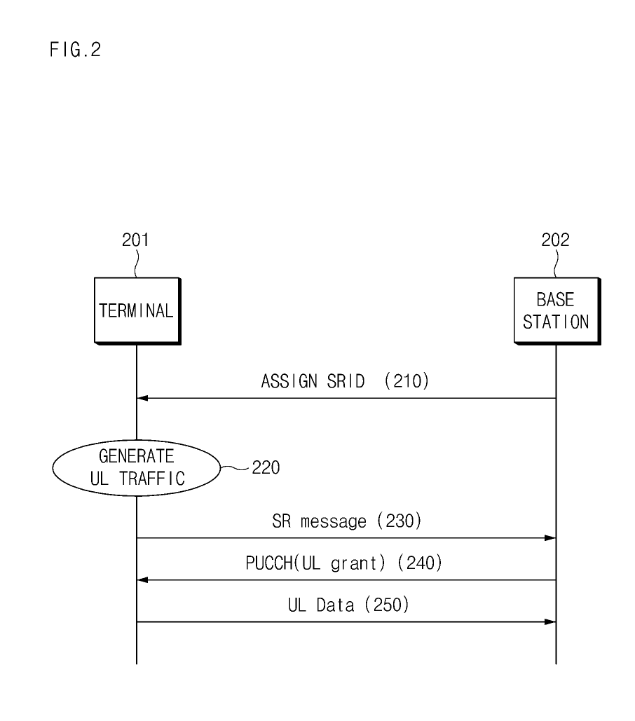

FIG. 2 is a signal flow diagram illustrating a step for requesting an uplink resource according to various embodiments of the present disclosure.

Referring to FIG. 2, at step 210, a terminal 201 may perform a connection setting with a base station 202 and may be assigned a SR Identifier (SRID).

At step 220, the terminal 201 may determine whether uplink traffic is generated.

At step 230, when the uplink traffic is generated, the terminal 201 may configure a SR message to transmit to the base station 202. In various embodiments, the SR message may be configured as follows.

SR message=u-bits UEID|b-bits buffer size index|c-bits CRC.

A value corresponding to the u-bits of least significant bit (LSB) of the SRID received at step 210 may be mapped to the u-bits UEID. The b-bits buffer size index may be a size of a buffer that stores current data in the terminal 201. The buffer size index may be mapped by finding an index corresponding to a buffer size of the terminal in a buffer size table. The c-bits CRC may be assigned a cyclic redundancy check (CRC) value for u-bits UEID|b-bits buffer size index. A length of the SR message may be determined by (u+b+c).

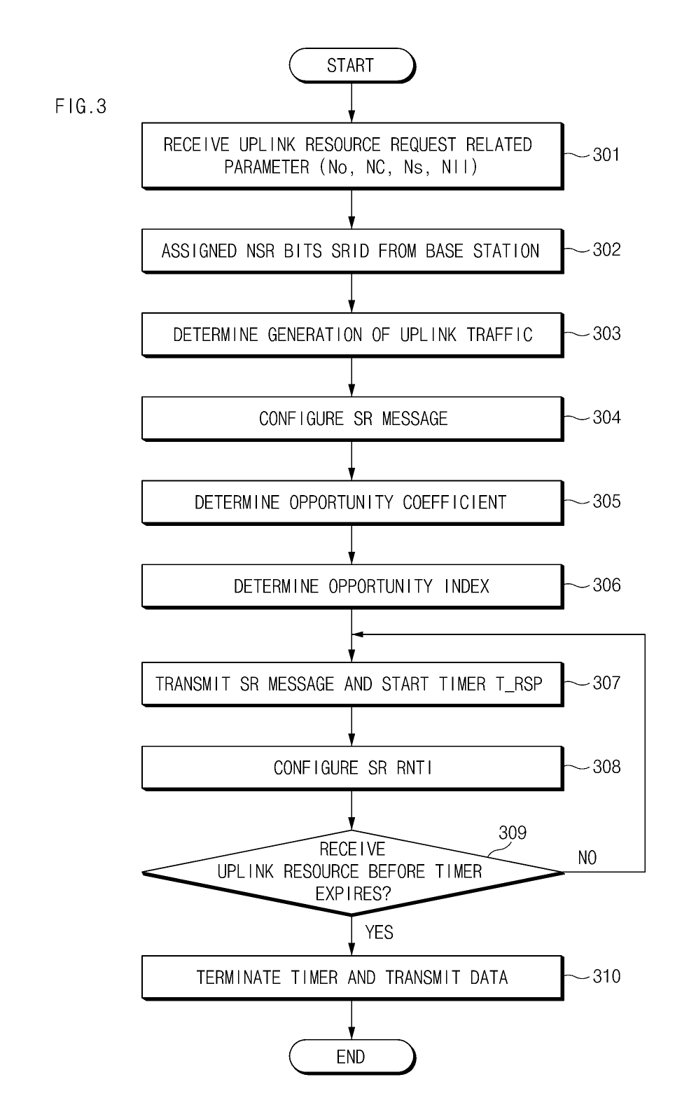

According to various embodiments, the terminal 201 may determine opportunity index corresponding to the SR channel in order to transmit the configured SR message. The terminal 201 may previously receive an uplink resource request related parameter broadcasted from the base station 202. The terminal 201 may determine the opportunity index based on the received parameter. The terminal 201 may transmit the SR message in the SR channel indicated by the determined opportunity index. Information on how to derive the opportunity index may be provided through FIG. 3.

At step 240, the base station 202 may configure the SR Radio Network Temporary Identifier (RNTI), and may assign the uplink resource to a physical downlink control channel (PDCCH) through the SR RNTI.

At step 250, the terminal 201 may send state link data using the assigned resource.

FIG. 3 is a flow chart illustrating a process of requesting an uplink resource by a terminal according to various embodiments of the present disclosure.

Referring to FIG. 3, at step 301, the terminal 201 may receive the uplink resource request related parameter broadcasted from the base station 202. In various embodiments, the terminal 201 may obtain Nf, Ns, Nc and No from system information broadcasted from the base station 202. The Nf may represent the number of frame, the Ns may represent the number of sub-frame, the Nc may represent the number of a SR channel per sub-frame, and the No may represent the number of opportunity which can transmit the SR message per SR channel.

At step 302, the terminal 201 may set a connection with the base station, and, at this time, may be assigned the SRID of Nsr bits.

At step 303, the terminal 201 may determine whether uplink traffic is generated.

At step 304, the terminal 201 may configure a SR message, when the uplink traffic is generated. The SR message may be configured as follows.

SR message=u-bits UEID|b-bits buffer size index|c-bits CRC;

The terminal 201 may map a LSB u-bits value of SRID to the UEID. In addition, the terminal 201 may determine the b-bits buffer size index based on a buffer size storing the uplink traffic. Then, the terminal 201 may calculate the value of c-bits CRC based on the u-bits UEID|b-bits buffer size index.

At step 305, the terminal 201 may determine an opportunity coefficient. The opportunity coefficient may be changed according to a SR cycle. The SR cycle may be a cycle that can transmit the SR message, and may be determined as Ns when the Nf is 1. In this case, the total opportunity coefficient N_to that can transmit the SR message in the SR cycle may be determined as follows.

N_to=No*Nc*Ns;

When the Nf is greater than 1, the SR cycle may be determined as Ns*Nf. In this case, the opportunity coefficient N_to that can transmit the SR message in the SR cycle may be determined as follows.

N_to=No*Nc*Ns*Nf;

At step 306, the terminal 201 may determine the opportunity index Tx_o to transmit the SR message as follows:

Tx_o=M%N_to.

Here, the N_to is the opportunity coefficient, and, assuming that a length of the SRID is Nsr bits, the M is determined as follows.

M=MSB (Most Significant Bit)(Nsr−u) bits;

Here, the u represents a length of the u-bits UEID in the above SR message configuration.

At step 307, the terminal 201 may transmit the SR message, and may drive T_rsp which is a response timer for this. The terminal 201 may transmit the SR message in the SR channel indicated by the opportunity index determined at step 306.

At step 308, the terminal 201 may configured a SR radio network temporary identifier (RNTI). The SR RNTI may be calculated as (SR RNTI indicator|opportunity index Tx_o|UEID).

At step 309, the terminal 201 may determine whether the PDCCH receives the uplink resource assigned to the SR RNTI before the response timer T_rsp expires. When the response timer T_rsp expires, a retry may be accomplished after a back-off for a specified time.

At step 310, when receiving the uplink resource assigned to the SR RNTI, the terminal 201 may terminate the response timer T_rsp and transmit data using the assigned resource.

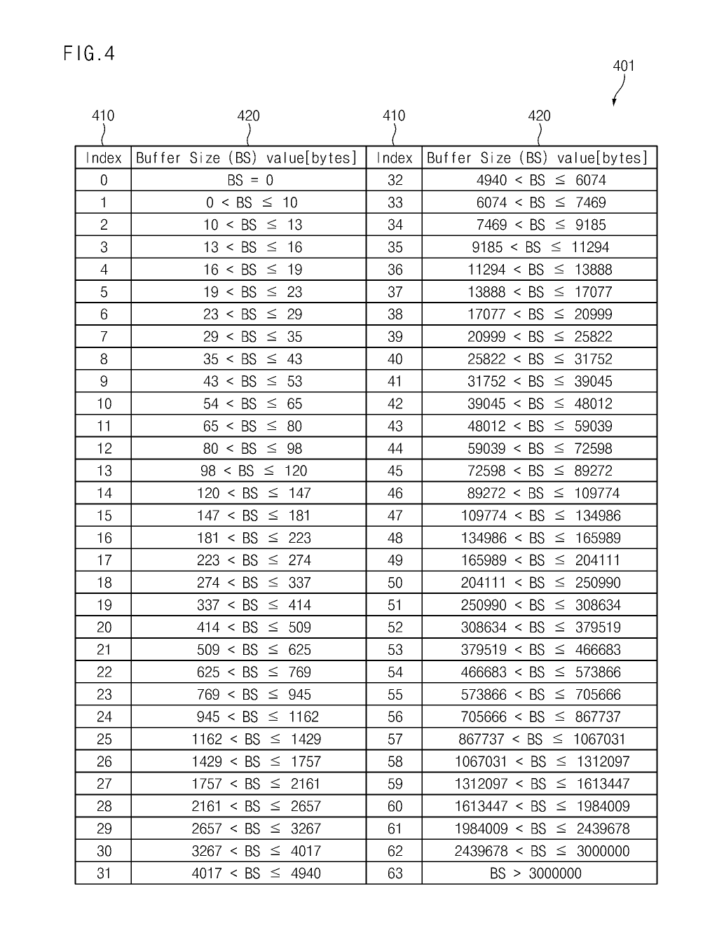

FIG. 4 is a diagram illustrating a buffer size table according to various embodiments of the present disclosure.

Referring to FIG. 4, the terminal 201 may determine the b-bits buffer size index based on the buffer size storing a corresponding traffic, when the uplink traffic is generated. The determined b-bits buffer size index may be used to configure the SR message.

The terminal 201 may find an index corresponding to the size of traffic from a buffer size table 401 and map to the buffer size index.

For example, when the buffer size storing the data is 121 bytes, a value 14 may be mapped to the buffer size index. For another example, when the buffer size storing the data is 109776 bytes, a value 47 may be mapped to the buffer size index. In addition, when the buffer size storing the data exceeds 3000000 bytes, a value 63 may be mapped to the buffer size index.

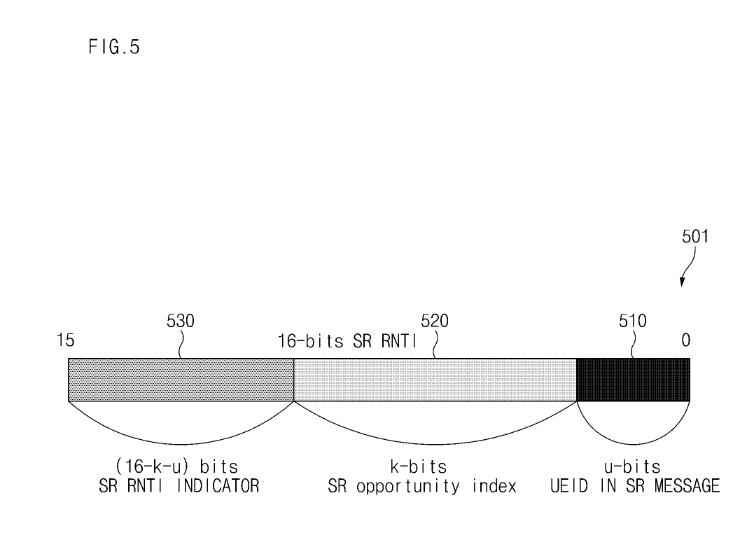

FIG. 5 is a diagram illustrating a configuration of SR RNTI according to various embodiments of the present disclosure.

Referring to FIG. 5, the terminal 201 may transmit the SR message and configure a SR radio network temporary identifier (RNTI) 501. The SR RNTI 501 may include a UEID 510 in the SR message, a SR opportunity index 520, and a SR RNTI indicator 530.

The UEID 510 may be a value corresponding to the LSB u-bits of SRID.

The SR opportunity index 520 may be a value indicating the SR channel that can transmit the SR message.

The SR RNTI indicator 530 may indicate that it is assigned for the SR in the 16 bits RNTI.

According to various embodiments, after receiving the SR message from the terminal 201, the base station 202 may assign the uplink resource to the PDCCH through the SR RNTI. The base station 202 may receive the SR message to perform a CRC check. The base station 202 may assign the uplink resource as much as a size indicated by the buffer size index when the CRC check is successful. In addition, the base station 202 may determine the SR RNTI through the opportunity index received the SR message and transmit uplink assignment information in the PDCCH to the terminal 201 using the determined SR RNTI.

The terminal 201 may check whether the uplink resource assigned to the SR RNTI exists in the PDCCH by using the SR RNTI obtained in the base station 202. When the assigned resource exists, the terminal 201 may transmit the uplink data by using the assigned resource.

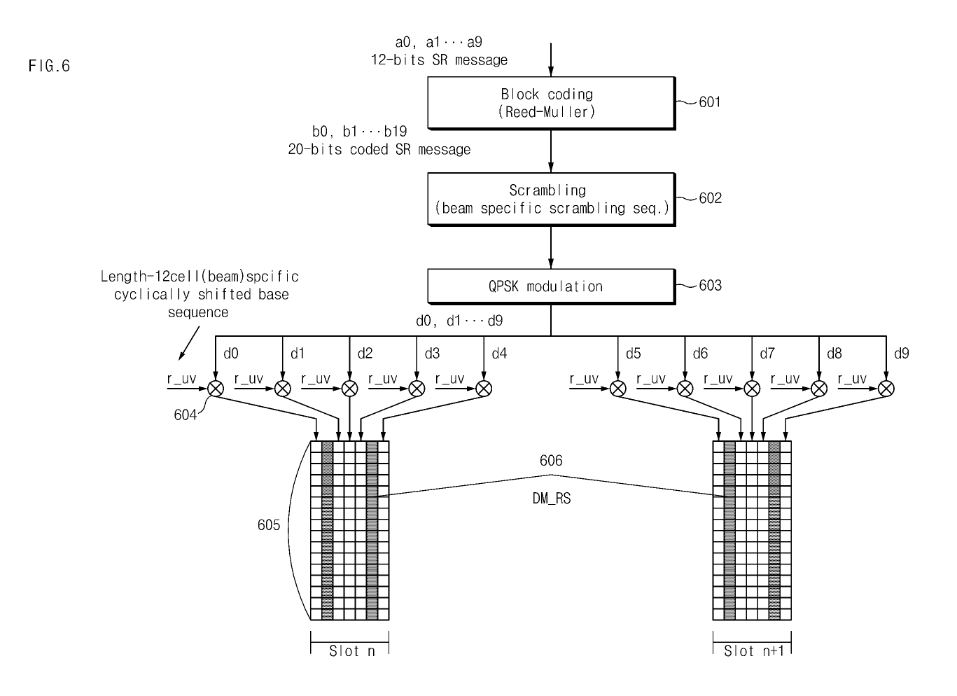

FIG. 6 is a diagram illustrating a method of configuring an SR channel using a CQI channel according to various embodiments of the present disclosure.

Referring to FIG. 6, the resource for transmitting the SR message may use a channel structure used to transmit a 10 bits CQI message in LTE-A. One resource block (RB) 605 may be configured of twelve sub-carriers and seven OFDM symbols. One RB 605 of two consecutive slots may configure one CQI channel. After coding and modulating with QPSK 1/2, the 10 bits CQI message may be multiplied with a length-12 cell specific cyclically shifted base sequence and transmitted. In this case, since maximum twelve times rotations of base sequence may be accomplished in one CQI channel, maximum twelve CQI messages may be transmitted simultaneously.

When the SR message is configured of u-bits UEID|b-bits buffer size index|c-bits CRC, the length of the SR message may be u+b+c and may be equal to the number of the remaining symbols excluding the symbol assigned for the transmission of DM-RS 606.

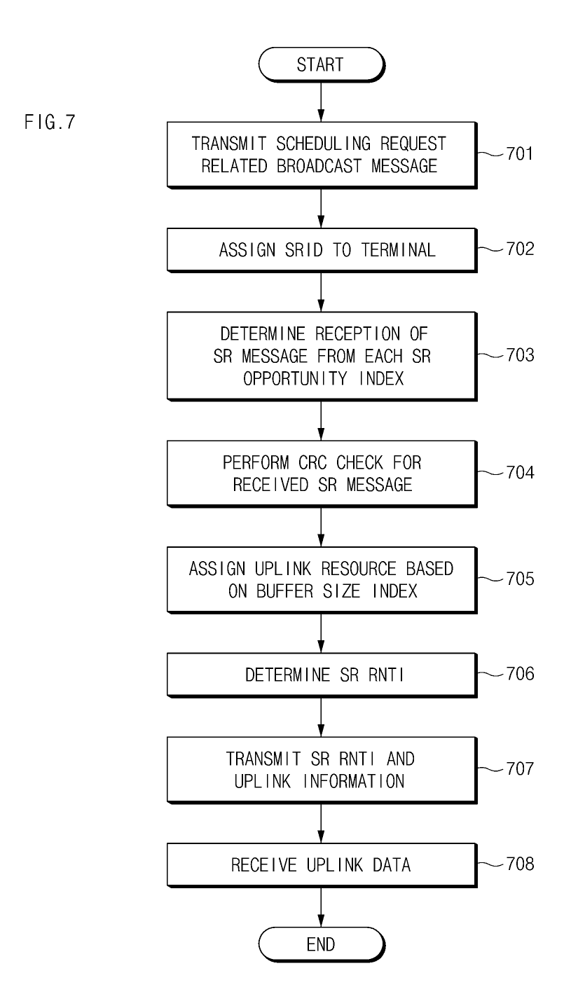

FIG. 7 is a flow chart illustrating a procedure for processing an uplink resource in a base station according to various embodiments of the present disclosure.

Referring to FIG. 7, at step 701, the base station 202 may transmit a scheduling request related broadcast message. In various embodiments, the base station 202 may transmit parameters No, Nc, Ns and Nf for the scheduling request through broadcast information. The Nf may represent the number of frame, the Ns may represent the number of sub-frame, the Nc may represent the number of a SR channel per sub-frame, and the No may represent the number of opportunity which can transmit the SR message per SR channel.

At step 702, the base station 202 may assign the SRID to the terminal 201 in a procedure of connection with the terminal 201.

At step 703, the base station 202 may determine the reception of the SR message from each of the SR opportunity index.

At step 704, when a received SR message exists, the base station 202 may perform a CRC check.

At step 705, when the CRC check for the SR message is successful, the base station 202 may assign the uplink resource based on the buffer size index of the SR message.

At step 706, the base station 202 may determine the SR RNTI using the opportunity index in which the SR message is received and the UEID in the SR message.

At step 707, the base station 202 may transmit the SR RNTI and the assigned uplink information. In various embodiments, the base station 202 may transmit the uplink assignment information in the PDCCH to the terminal 201 using the SR RNTI.

At step 708, the base station 202 may receive uplink data from the terminal 201.

According to the present disclosure, when the terminal requires an uplink resource, a delay due to uplink data transmission in the terminal may be effectively reduced through a shortened resource request procedure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for transmitting data between a terminal and a base station, the method comprising:
being assigned a scheduling request identifier (SRID) through a connection with the base station, in the terminal;
configuring a scheduling request (SR) message and transmitting the scheduling request message to the base station when uplink traffic is generated, in the terminal;
assigning an uplink resource based on the scheduling request message, in the base station; and
transmitting data using the uplink resource, in the terminal.

2. The method of claim 1, wherein being assigned a scheduling request identifier comprises receiving an uplink resource request related parameter which is broadcasted by the base station.

3. The method of claim 2, wherein receiving an uplink resource request related parameter comprises receiving at least one of the number of frame, the number of sub frame, the number of a SR channel per sub-frame, and the number of opportunity which is able to transmit the SR message per SR channel.

4. The method of claim 1, wherein configuring a scheduling request message comprises configuring the scheduling request message using a specified bit value of the scheduling request identifier, a buffer size in which the uplink traffic is stored, the bit value, and a cyclic redundancy check (CRC) value for the buffer size.

5. The method of claim 1, wherein transmitting the scheduling request message comprises transmitting the scheduling request message based on opportunity index indicating a scheduling request channel.

6. The method of claim 5, wherein transmitting the scheduling request message comprises determining the opportunity index based on a following equation.
Opportunity Index=M%N_to [Equation]
(where, the M is most significant bit (MSB) (Nsr−u) bits, the Nsr is a length of the scheduling request identifier, the U is a specified bit value of the scheduling request identifier, the N_to is No*Nc*Ns (when Nf is 1) or No*Nc*Ns*Nf (when Nf is greater than 1), the Nf is the number of frame, the Ns is the number of sub-frame, the Nc is the number of a SR channel per sub-frame, and the No is the number of opportunity which is able to transmit the SR message per SR channel).

7. The method of claim 1, wherein transmitting the scheduling request message comprises driving a response timer corresponding to the scheduling request message.

8. The method of claim 1, wherein assigning an uplink resource comprises:
configuring a SR radio network temporary identifier (RNTI), in the base station; and
assigning the uplink resource through a physical downlink control channel (PDCCH), in the base station.

9. The method of claim 8, wherein configuring the SR RNTI further comprises performing a CRC for the scheduling request message.

10. The method of claim 8, wherein assigning an uplink resource comprises assigning the uplink resource based on a size of a buffer storing the uplink traffic.

11. The method of claim 1, wherein configuring a scheduling request (SR) message and transmitting comprises forming a scheduling request channel for transmitting the scheduling request message using a CQI message.
